(19) United States
(12) Patent Application Publication
(10) Pub. No.: US 2025/0024813 A1
(43) Pub. Date: Jan. 23, 2025

(54) AGITATING MECHANISM FOR USE IN A VACUUM-POWERED AGRICULTURAL WASTE COLLECTOR

(71) Applicant: Mensch Manufacturing, L.L.C., Hastings, MI (US)

(72) Inventors: Donald L. Mensch, Hastings, MI (US); Noah Mensch, Hastings, MI (US)

(73) Assignee: Mensch Manufacturing, L.L.C., Hastings, MI (US)

(21) Appl. No.: 18/774,236

(22) Filed: Jul. 16, 2024

Related U.S. Application Data
(60) Provisional application No. 63/513,948, filed on Jul. 17, 2023.

(51) Int. Cl. A01K 1/01; B08B 5/04

(52) U.S. Cl. CPC A01K 1/0128; B08B 5/04

(57) ABSTRACT

A vehicle for a livestock facility includes a storage tank positioned on a vehicle frame, a collector frame attached to the vehicle frame, first and second operable arms that are attached to the collector frame and positioned proximate a front of the collector frame, a vacuum system having a suction inlet that extends from proximate the collection area to the storage tank, and an agitating mechanism that is positioned within the collection area. The first and second operable arms at least partially define a collection area. The agitating mechanism operates within the collection area to process waste material and direct waste material toward the suction inlet.

### CROSS-REFERENCE TO RELATED APPLICATION

This application claims priority to and the benefit under 35 U.S.C. § 119 (e) of U.S. Provisional Patent Application No. 63/513,948, filed on Jul. 17, 2023, entitled AGITATING MECHANISM FOR USE IN A VACUUM-POWERED AGRICULTURAL WASTE COLLECTOR, the entire disclosure of which is hereby incorporated herein by reference.

### FIELD OF THE INVENTION

The present invention generally relates to vehicles used on agricultural and livestock facilities, and more specifically, an agitating mechanism, such as an agitator and/or an auger, that is used for assisting a vacuum-powered waste collector to collect waste material within an agricultural or livestock facility.

### BACKGROUND OF THE INVENTION

Within agricultural and livestock facilities, various waste materials, such as animal waste, plant material, dirt and other waste materials can accumulate within these facilities. Removal of these materials is important in maintaining the health of livestock and the quality of products produced by livestock. Collection of these waste materials is a continual process that can take up a large amount of labor hours and must be conducted year-round, and typically multiple times each day.

### SUMMARY OF THE INVENTION

According to one aspect of the present invention, a vehicle for a livestock facility includes a storage tank positioned on a vehicle frame, a collector frame attached to the vehicle frame, first and second operable arms that are attached to the collector frame and positioned proximate a front of the collector frame, a vacuum system having a suction inlet that extends from proximate the collection area to the storage tank, and an agitating mechanism that is positioned within the collection area. The first and second operable arms at least partially define a collection area. The agitating mechanism operates within the collection area to process waste material and direct waste material toward the suction inlet.

According to another aspect of the present invention, a vehicle for a livestock facility includes a collector frame, opposing arms, a suction inlet, and an auger. The collector frame is configured to attach to a vehicle frame. The opposing arms are operably attached to the collector frame and define a collection region. The suction inlet is attached to the collector frame and is positioned proximate to a first operable arm of the opposing arms. The suction inlet is configured to draw a waste material away from the collection region. The auger has a drive end and an exit end. The drive end is attached to the collector frame and is positioned proximate to a second operable arm of the opposing arms. The exit end is positioned proximate the suction inlet. The auger rotates within a collection area and is configured to direct the waste material toward the suction inlet.

According to yet another aspect of the present invention, a waste collection assembly for a vehicle includes a collector frame, opposing operable arms, a suction inlet, and an auger. The collector frame has an attachment interface for attaching to a vehicle frame. The collector frame has a first side and a second side that are divided by an axis of symmetry. The opposing operable arms are attached to the collector frame and define a collection region. The suction inlet is attached to the first side of the collector frame and is configured to draw a waste material away from the collection region. The auger has a drive end that is attached to the second side of the collector frame and an exit end that is attached to the suction inlet. The auger rotates within a collection area and is configured to direct the waste material toward the suction inlet.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a top perspective view of an agricultural vehicle incorporating an aspect of the agitating mechanism for use in connection with a vacuum-powered collector;

FIG. 2 is a front perspective view of an agricultural vehicle incorporating an aspect of the agitating mechanism;

FIG. 3 is a top plan view of a collector frame that carries the agitating mechanism and aligns the suction inlet for the vacuum-powered collector;

FIG. 4 is a cross-sectional view of a front portion of the agricultural vehicle and illustrating operation of the agitating mechanism and the vacuum-powered collector;

FIG. 5 is a top perspective view of an aspect of the agitating fins for the agitating mechanism;

FIG. 6 is a top perspective view of an aspect of the collector frame for use with the agricultural vehicle;

FIG. 7 is a cross-sectional view of the collector frame of FIG. 4 taken at area VII and showing operation of the agitating mechanism and the vacuum-powered collector;

FIG. 8 is a schematic plan view of a livestock facility within which the agricultural vehicle may operate;

FIG. 9 is a top perspective view of an aspect of the collector frame for use with an agricultural vehicle;

FIG. 10 is a front elevation view of the collector frame of FIG. 9;

FIG. 11 is a top plan view of the collector frame of FIG. 9;

FIG. 12 is a bottom plan view of the collector frame of FIG. 9 showing operation of the auger to move waste material to the suction inlet;

FIG. 13 is a side elevation view of the collector frame of FIG. 9; and

FIG. 14 is an exploded perspective view of the collector frame of FIG. 9.

### DETAILED DESCRIPTION OF THE PREFERRED EMBODIMENTS

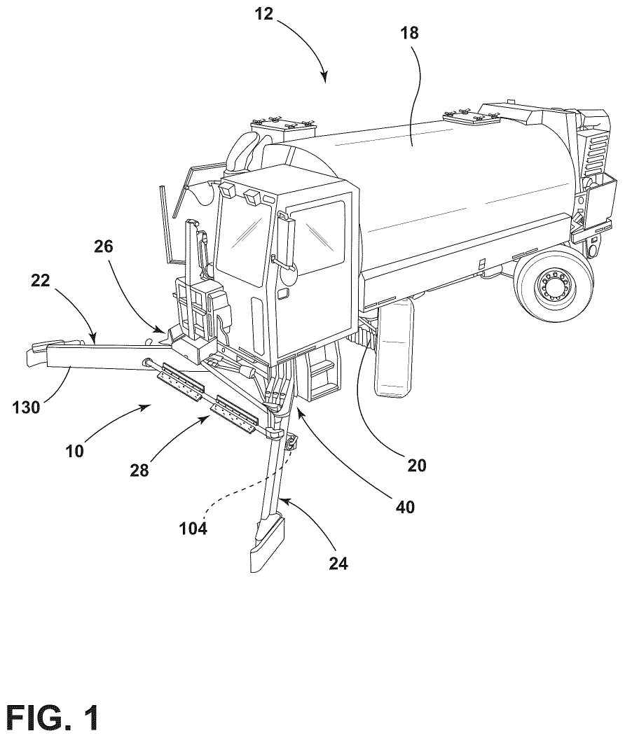

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

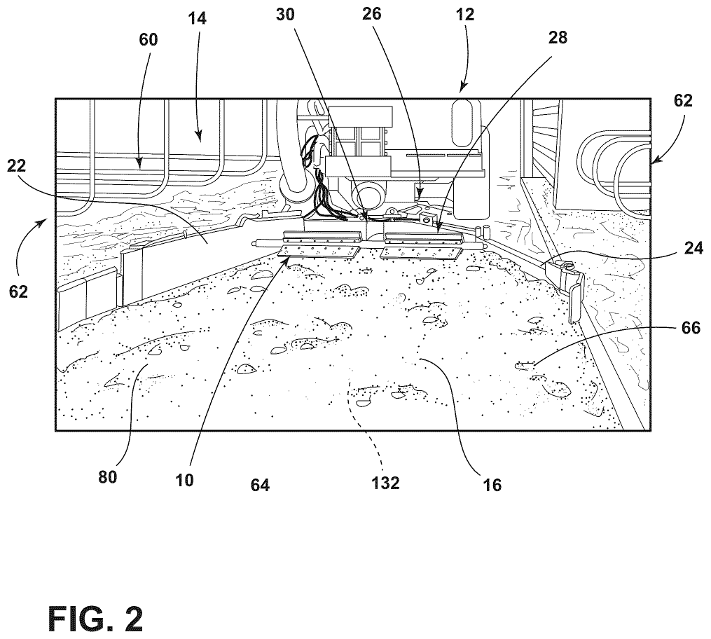

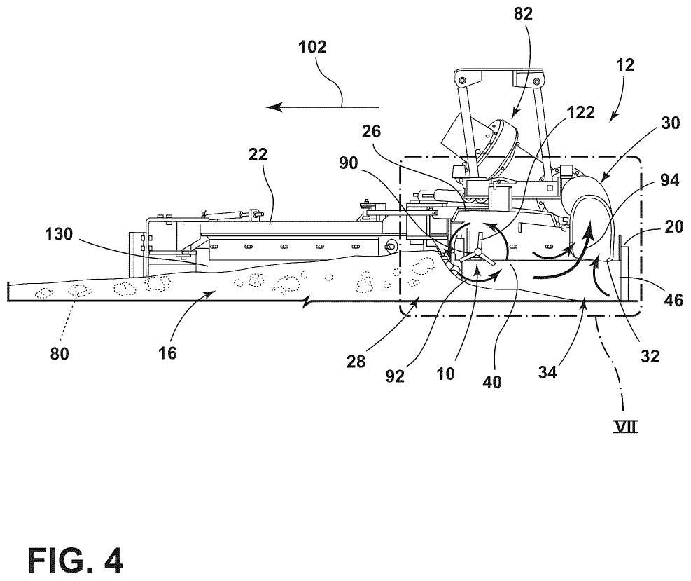

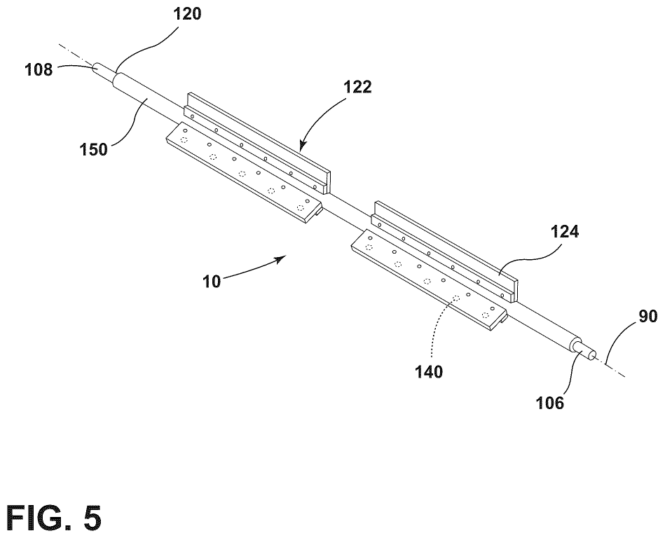

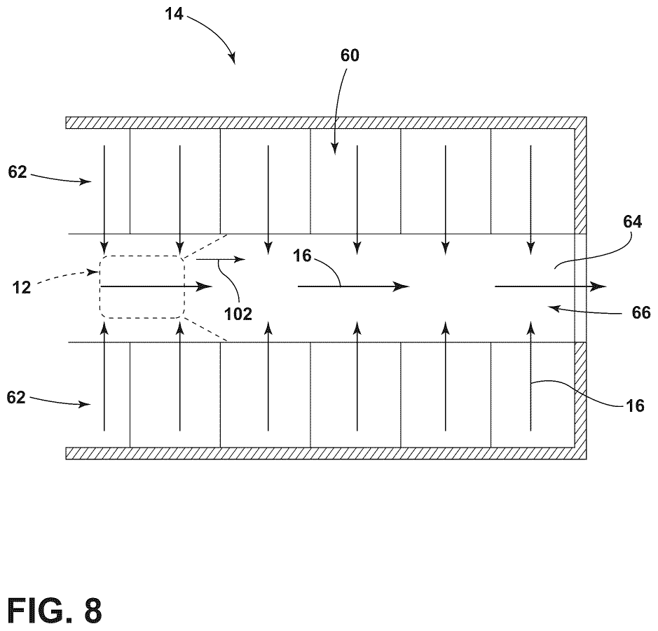

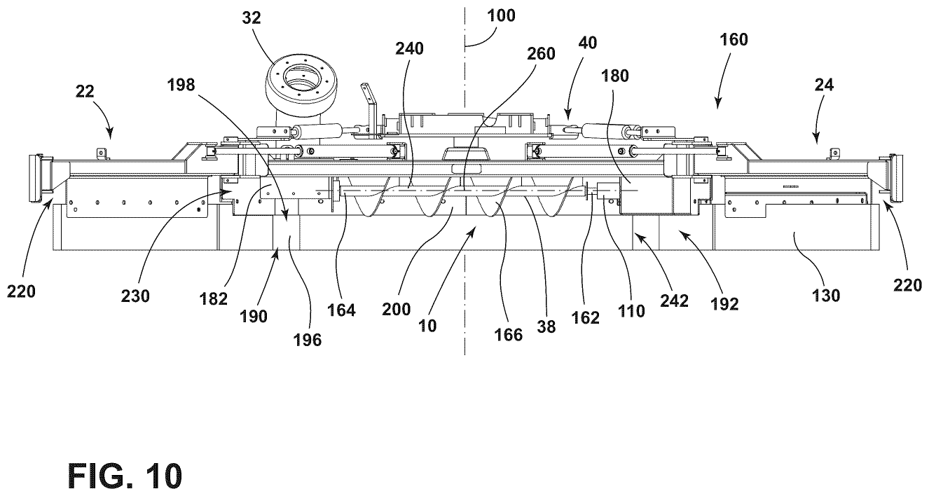

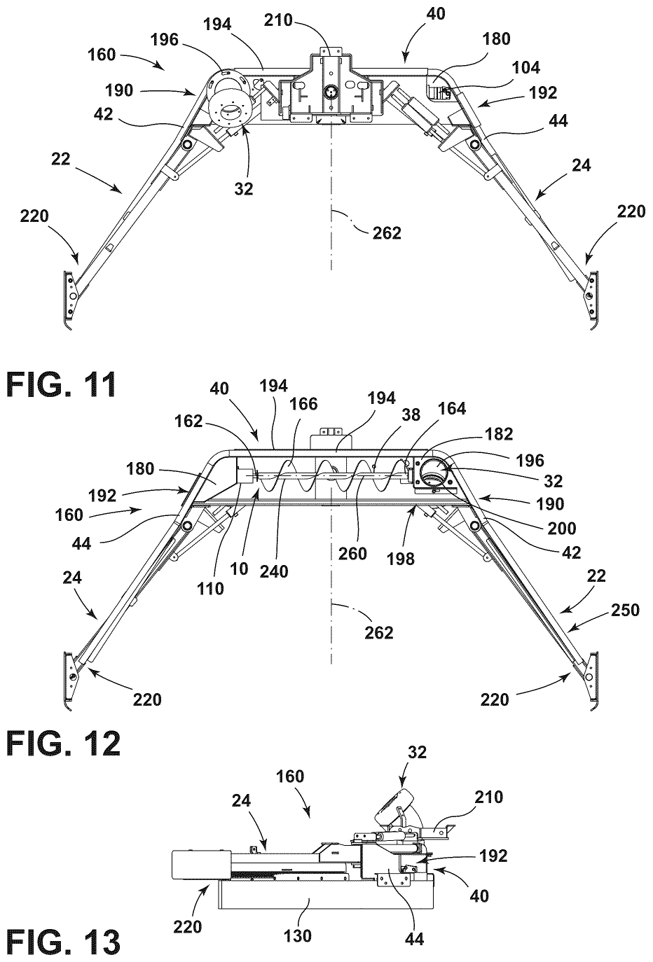

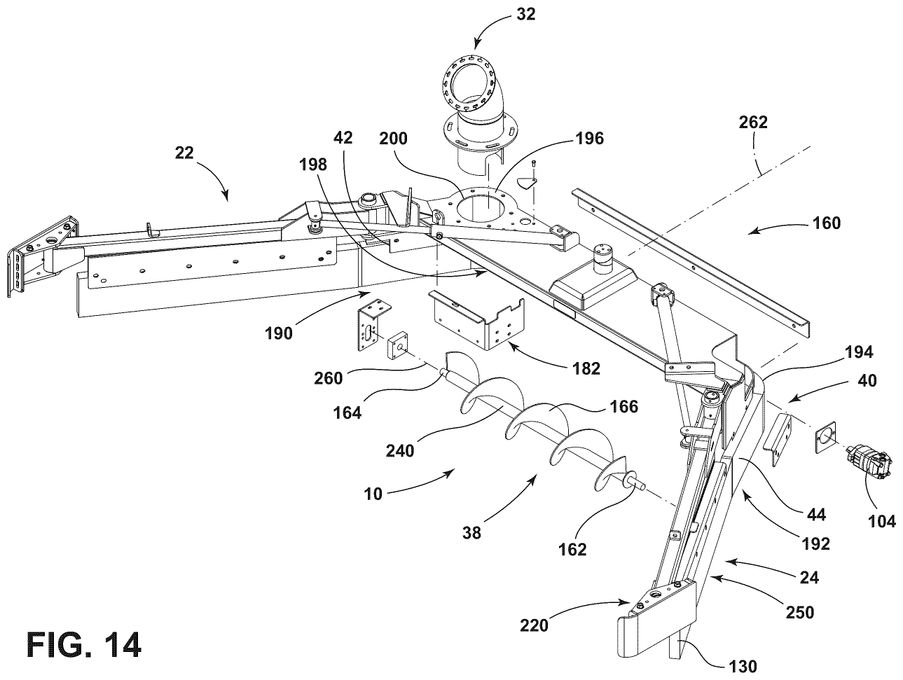

As exemplified in FIGS. 1-14, reference numeral 10 generally refers to an agitating mechanism for use in connection with an agricultural vehicle 12 that can be utilized within agricultural facilities and livestock facilities 14 (shown in FIG. 8) for collecting waste material 16 to be disposed of outside of these facilities. According to various aspects of the device, the agricultural vehicle 12 for use in a livestock facility 14 can include a storage tank 18 positioned on a vehicle frame 20. First and second operable arms 22, 24 are positioned proximate a front 26 of the vehicle frame 20. The first and second operable arms 22, 24 at least partially define a gathering region 28 where waste material 16 is configured to be funneled through the use of first and second operable arms 22, 24. A vacuum system 30 includes a suction inlet 32 that extends from proximate the gathering region 28 and to the storage tank 18. The agitating mechanism 10 is positioned within the gathering region 28. The agitating mechanism 10 operates within a collection area 66 of the gathering region 28 to process waste material 16 and direct the waste material 16 toward the suction inlet 32. Typically, the suction inlet 32 is positioned within an area where the first and second operable arms 22, 24 can funnel the waste material 16 to the agitating mechanism 10 for processing toward the suction inlet 32. Accordingly, the suction inlet 32 is positioned near the vehicle frame 20 and within a rearward position 34 of the collection area 66, downstream of the agitating mechanism 10.

Referring again to FIGS. 1-6 and 9-14, the first and second operable arms 22, 24 are connected to the vehicle frame 20 via a collector frame 40. The first and second operable arms 22, 24 are at least rotationally operable relative to the collector frame 40. The collector frame 40 can include first and second angled members 42, 44 that are held in a generally fixed position with respect to one another. The first and second angled members 42, 44 extend generally outward to engage the first and second operable arms 22, 24, respectively. The suction inlet 32 is typically located at an apex 46 of the first and second angled members 42, 44 of the collector frame 40. In this manner, the first and second operable arms 22, 24 and the first and second angled members 42, 44 direct the waste material 16 toward the suction inlet 32. The agitating mechanism 10 is typically attached to the collector frame 40 and extends through a portion of the gathering region 28 defined within the collector frame 40. As discussed herein, the agitating mechanism 10 operates within a collection area 66 of the gathering region 28 to direct the processed waste 94 toward the suction inlet 32. Typically, the suction inlet 32 is positioned between the apex 46 of the first and second angled members 42, 44 and the agitating mechanism 10. Accordingly, operation of the agitating mechanism 10 can serve to direct, or at least partially direct, the waste material 16 toward the suction inlet 32.

As exemplified in FIG. 8, the livestock facility 14 typically includes a plurality of linearly situated stalls 60 for housing livestock. Between opposing rows 62 of these linearly situated stalls 60 is a central corridor 64 that extends between the opposing rows 62 of livestock stalls 60. Through the course of the day, the livestock within the various stalls 60 produce waste material 16. This waste material 16 is funneled toward the central corridor 64 either by manual labor or by some automated mechanism or process. The central corridor 64 serves as a collection area 66 for accumulating various waste material 16 to be disposed of from the livestock facility 14. This disposal of waste material 16 from the central corridor 64 can occur daily, multiple times daily, or other time period required for operation of the facility.

Referring again to FIGS. 1-14, during certain times of the year and in various geographic locations, temperatures within the livestock facility 14 can fall below the freezing point of water. During these times, the waste material 16 that accumulates within the collection area 66 of the central corridor 64 for the livestock facility 14 can become frozen and can accumulate into clumps 80 of waste material 16. These clumps 80 of waste material 16 may cause a blockage within the vacuum-powered collector 82 of the vacuum system 30 and may also be difficult to move through the vacuum-powered collector 82 and into the storage tank 18. The clumps 80 of waste material 16 can also cause backups within the gathering region 28 defined within the collector frame 40. In this manner, large clumps 80 of waste material 16 may accumulate within the gathering region 28. These larger clumps 80 of waste material 16 can exceed the capacity of the vacuum-powered collector 82 and also cause clogging within the vacuum-powered collector 82. Through the use of the agitating mechanism 10, clumps 80 and/or frozen portions of the waste material 16 can be broken up into smaller clumps 80 within the collection area 66 and also broken up and mixed with warmer sections of waste material 16 to provide a more flowable form of the waste material 16 that can be better accumulated and moved through use of the vacuum-powered collector 82. Additionally, through the use of the agitating mechanism 10, the clumps 80 of waste material 16 can be processed into smaller agglomerations of waste and also moved through the collection area 66 and toward the suction inlet 32 in a more consistent or regularized flow of waste material 16. Accordingly, the agitating mechanism 10 can provide for a buildup of larger clumps 80 of waste material 16 within the gathering region 28 and the collection area 66 thereof and also provide for consistent and regularized processing and movement of this waste material 16 toward the suction inlet 32. Accordingly, blockages within the vacuum-powered collector 82 can be kept to a minimum and potentially eliminated through the use of the agitating mechanism 10.

As exemplified in FIGS. 1-14, various forms of waste material 16 may become frozen during sub-freezing temperatures. It is also possible that waste material 16 can become dried out and hardened if extended periods of time have lapsed since the previous cleaning within the collection area 66 of the central corridor 64. Through the use of the agitating mechanism 10, these hardened portions of the waste material 16 can be processed by the agitating mechanism 10 and broken into smaller pieces of processed waste 94 that can be conveniently moved through the suction inlet 32 and into the vacuum-powered collector 82.

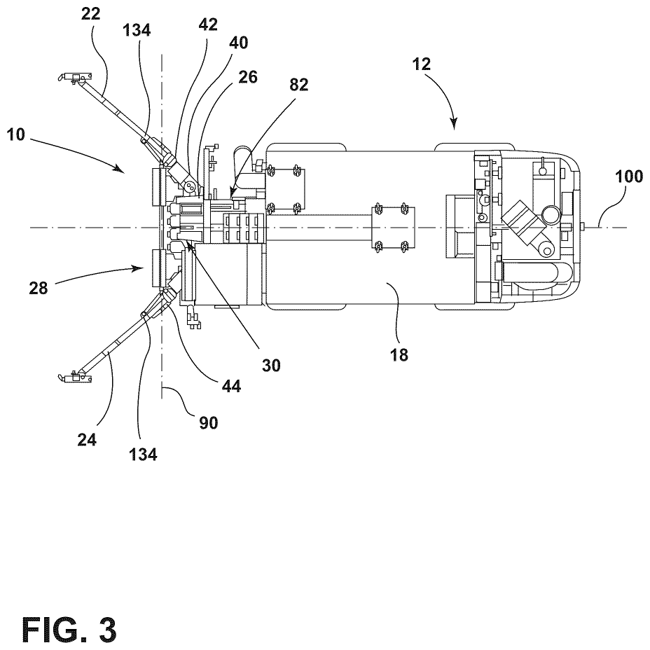

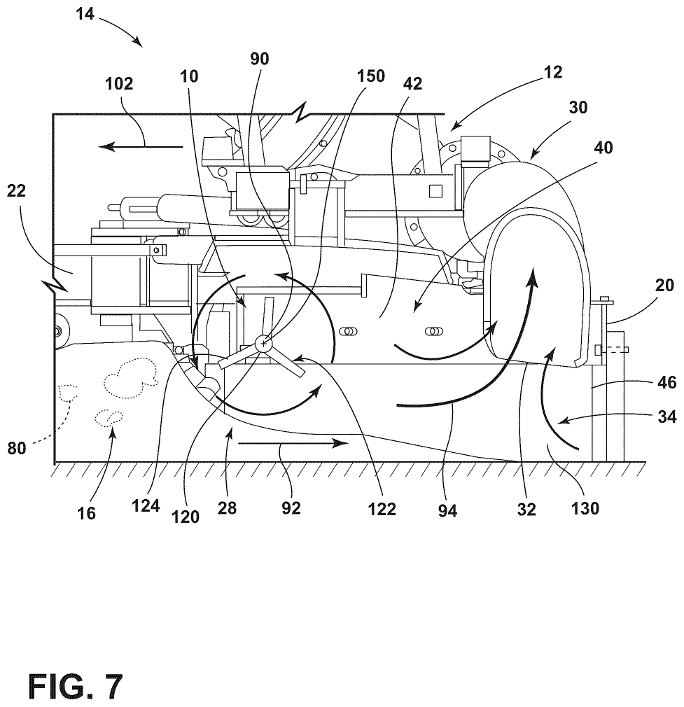

Through the use of the agitating mechanism 10, as exemplified in FIGS. 3 and 7, the agitating mechanism 10 can rotate about a horizontal axis 90 and process the waste material 16 into a consistent flow of processed waste 94 toward the suction inlet 32. The rotation of the agitating mechanism 10 about the horizontal axis 90 also causes a general movement 92 of the processed waste 94 in a rearward direction through the collection area 66 and toward the suction inlet 32. This movement 92 of the processed waste 94 can be utilized in eliminating a buildup or excessive accumulation of waste material 16 within the collection area 66 in an area upstream of the agitating mechanism 10.

Referring again to FIGS. 1-7 and 9-14, the agitating mechanism 10 operates about a rotational horizontal axis 90 that extends perpendicular to an axis of symmetry 100 of the collector frame 40. Accordingly, during forward movement 102 of the agricultural vehicle 12, operation of the agitating mechanism 10 moves waste material 16. The operation of the vehicle 12 and the agitating mechanism 10 creates the movement 92 of the processed waste 94, in a generally rearward and/or generally lateral direction, relative to the collector frame 40, and toward the suction inlet 32 of the vacuum-powered collector 82. The agitating mechanism 10 is typically powered by a single motor 104 that is attached to the collector frame 40. Typically, the motor 104 attaches to only a first end 106 of the agitating mechanism 10 and provides for rotation of the entire agitating mechanism 10 through the collection area 66. The second end 108 of the agitating mechanism 10 can include a bearing 110 or other idling mechanism for allowing more consistent rotation of the agitating mechanism 10 about the horizontal axis 90 during operation of the motor 104. According to various aspects of the device, the motor 104 can be a variable speed motor 104. Accordingly, depending upon the amount of waste material 16 to be processed, the agitating mechanism 10 can be increased or decreased in speed, depending upon the needs of the user within the livestock facility 14.

By way of example, and not limitation, where a large accumulation of waste material 16 may gather upstream of the agitating mechanism 10, the user may increase the speed of the motor 104 for increasing the rotation of the agitating mechanism 10, thereby providing increased processing capability of the agitating mechanism 10. This increased speed of the motor 104 can better process the accumulation of waste material 16 and provide for a consistent and regularized flow of waste material 16 toward the suction inlet 32. It is also contemplated that the speed of the agricultural vehicle 12 and the speed of the motor 104 for the agitating mechanism 10 may be operably related. In such an embodiment, an increased speed of the agricultural vehicle 12 may correspond to an increased speed of the agitating mechanism 10 to provide for greater processing capability at the increased speed of the agricultural vehicle 12.

Referring again to FIGS. 1-7, the agitating mechanism 10 can include a rotating shaft 120 that extends through the horizontal axis 90 of rotation for the agitating mechanism 10. The rotating shaft 120 can be an elongated member 150 that includes a plurality of agitating fins 122 that extend radially outward from the central rotating shaft 120. The agitating fins 122 can include a plurality of plates 124 that radiate outward from the central rotating shaft 120 at regular angular intervals. The agitating fins 122 of the agitating mechanism 10 can take the form of an agitator that manipulates the waste material 16. The agitating fins 122 can also be set at an angle to provide an auger-type configuration. This auger-type configuration can manipulate the waste material 16 and also move the waste material 16 in the direction of the suction inlet 32.

According to the various aspects of the device, as exemplified in FIGS. 1-7 and 9-14, the agitating fins 122 can take the form of multiple plates 124 that extend outward from the rotating shaft 120. During operation of the agitating mechanism 10, the agitating fins 122 engage the waste material 16 within the collection area 66. The agitating fins 122 then rotate to move portions of the waste material 16 in a generally rearward and/or lateral movement 92, and toward the suction inlet 32. The agitating fins 122 can also take the form of various fingers or elongated protrusions that cooperate with the agitating fins 122 for processing the waste material 16. As discussed herein, the agitating mechanism 10 can also include an auger-type configuration that further assists in moving the waste material 16 toward the suction inlet 32. The exact configuration of the agitating fins 122 can depend upon various factors. Such factors can include, but are not limited to, geographic location of the livestock facility 14, the type of animals kept within the livestock facility 14, the amount of waste material 16 being processed during operation of the agricultural vehicle 12, weather conditions, general climate of the location of the livestock facility 14, size of the livestock facility 14, and other similar considerations. It is further contemplated that several configurations of interchangeable agitating fins 122 can be used with the agitating mechanism 10 for processing waste material 16 in a variety of conditions and situations.

In various aspects of the device, first and second operable arms 22, 24 and the first and second angled members 42, 44 of the collector frame 40 can include a flexible member 130 that extends downward and engages the floor 132 of the livestock facility 14. This flexible member 130 serves to scrape against the floor 132 and funnel the waste material 16 into the gathering region 28 and toward the suction inlet 32. These flexible members 130 can also serve to direct the waste material 16 towards the agitating mechanism 10 for processing of the waste material 16 and moving the waste material 16 in a generally rearward and/or a generally lateral direction of movement 92 and toward the suction inlet 32. Additionally, the first and second operable arms 22, 24 can rotate about attachment ends 134 of the first and second angled members 42, 44 of the collector frame 40. Rotation of the first and second operable arms 22, 24 can serve to widen or narrow the gathering region 28 depending upon the width of the collection area 66 of the central corridor 64 and also depending upon any obstructions that may be present within the central corridor 64 or other area to be cleaned by the agricultural vehicle 12.

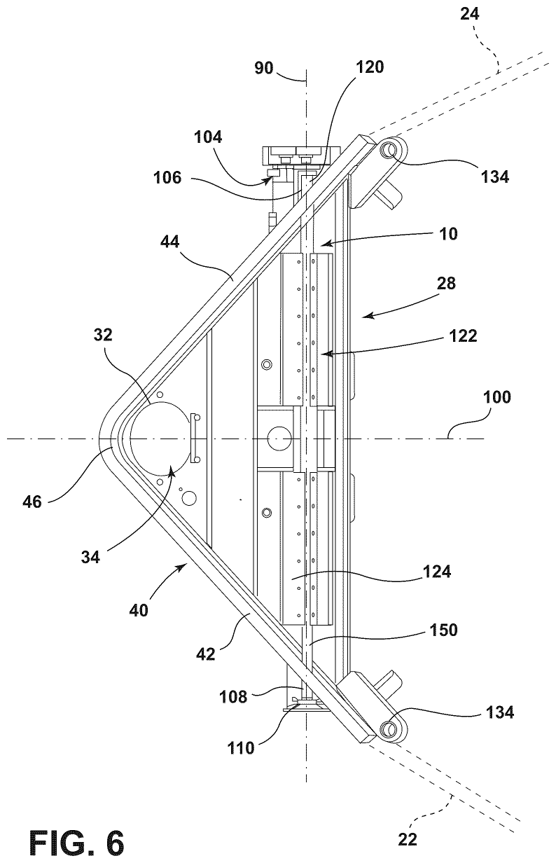

As exemplified in FIG. 6, the motor 104 for the agitating mechanism 10 can be positioned outside of the gathering region 28 and the collection area 66 defined by the first and second angled members 42, 44. By positioning the motor 104 outside of this collection area 66, the motor 104 can be substantially set apart from the waste material 16 that may serve to clog or otherwise impair the operation of the motor 104 for the agitating mechanism 10. The elongated member 150 of the agitating mechanism 10 can extend through each of the first and second angled members 42, 44 of the collector frame 40. Various bearings 110 and other idler or rotational assisting mechanisms can be positioned within the first and second angled members 42, 44 to provide for convenient rotation of the central rotating shaft 120 of the agitating mechanism 10 during operation of the agricultural vehicle 12.

In various aspects of the device, as exemplified in FIGS. 1-7 and 9-14, the elongated member 150, rotating shaft 120 and/or the agitating fins 122 can be removed and replaced to provide different functionality for the agitating mechanism 10. By way of example, and not limitation, an agitating mechanism 10 for the summer to be used during warmer conditions may be replaced with a set of agitating fins 122 that are better suited for winter conditions, and vice versa. According to various aspects of the device, the agitating fins 122 can take the form of plates 124, tines, teeth, wedges, scoops, paddles, various geometric protrusions, combinations thereof and other similar shapes. The various agitating fins 122 can also include apertures 140, serrations and various textures that can assist in the processing of waste material 16 in the direction of movement 92 toward the suction inlet 32. In addition to agitating fins 122 that extend outward from the elongated member 150 of the rotating shaft 120, the elongated member 150 can include extended portions, bent portions, angles, arcuate sections, and other geometric formations within the shape of the elongated member 150 that can serve to at least partially assist in the processing of the waste material 16 for movement 92 toward the suction inlet 32 of the vacuum-powered collector 82.

The vacuum-powered collector 82 serves to move the processed waste 94 from the agitating mechanism 10 through the suction inlet 32 and into the storage tank 18. The storage tank 18 can include a large tank that rests on the vehicle frame 20. The storage tank 18 can also include various disposal features that can include, but are not limited to, lifts, augers, conveyors, and other mechanisms that can move the processed waste 94 from the storage tank 18 and to a disposal site exterior to the livestock facility 14. Disposal of the waste material 16 can be used to spread fertilizer in the form of the waste material 16 onto desired portions of the livestock facility 14 external to the livestock structure.

Referring again to FIGS. 1-7 and 9-14, the vehicle 12 includes a storage tank 18 that is positioned on the vehicle frame 20. A collector frame 40 is attached to the vehicle frame 20. The first and second operable arms 22, 24 are attached to the collector frame 40, where the first and second operable arms 22, 24 at least partially define the gathering region 28. The vacuum system 30 includes the suction inlet 32 that extends from an area within or proximate to the collection area 66 to the storage tank 18. The agitating mechanism 10 is positioned within the collection area 66. The agitating mechanism 10 operates within this collection area 66 to process the waste material 16 and direct this waste material 16 toward the suction inlet 32. The agitating mechanism 10 is typically in the form of an auger 38 that operates to direct the waste material 16 toward the suction inlet 32.

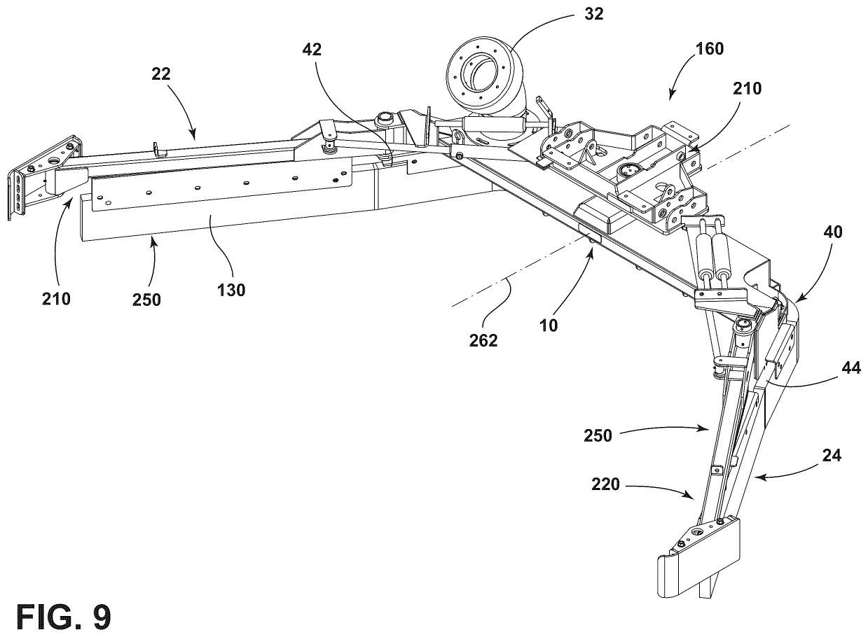

As exemplified in FIGS. 9-14, the suction inlet 32 can be positioned to one side of the collection area 66. In such an aspect of the device, the auger 38 includes a drive end 162 that is attached to the motor 104, and an exit end 164. The exit end 164 is the location where the threads 166 of the auger 38 direct waste material 16 during operation of the waste collection assembly 160. It is contemplated that the suction inlet 32 can be disposed proximate the exit end 164 of the auger 38. Accordingly, during operation of the auger 38, the thread 166 or a plurality of threads 166 manipulate the waste material 16 and bias the waste material 16 for movement toward the suction inlet 32.

Additionally, the auger 38 or other agitating mechanism 10 is operated by a dedicated motor 104 that is attached to the collector frame 40. The collector frame 40 includes the first and second angled members 42, 44 and defines the collection area 66. The motor 104 can be disposed within a motor housing 180 that is attached to the collector frame 40. Accordingly, the drive end 162 of the auger 38, which is attached to the motor 104, can be secured to and within the motor housing 180. The exit end 164 of the auger 38 can be attached to the opposing side of the collector frame 40 or can be attached to the suction inlet 32. In certain aspects of the device, the suction inlet 32 can include an inlet housing 182 that surrounds at least a portion of the suction inlet 32. The motor housing 180, as well as the suction inlet 32 or the inlet housing 182, can include a bearing 110 that receives the drive end 162 and the exit end 164 of the auger 38, respectively. In this manner, the auger 38 can rotate in an idling fashion at the exit end 164 to produce the rotational operation of the auger 38 that drives the waste material 16 along threads 166 and toward the suction inlet 32.

According to various aspects of the device, as illustrated in FIGS. 1-7 and 9-14, operation of the first and second operable arms 22, 24 and the first angled member 42 and second angled member 44 of the collector frame 40 directs waste material 16 into the collection area 66. When in this collection area 66, the waste material 16 is directed toward the auger 38 or other agitating mechanism 10. During operation of the waste collection assembly 160, the threads 166 of the auger 38 extend into the collection area 66 and process the waste material 16. In addition to processing waste material 16, such as through breaking larger clumps 80 of waste material 16 into smaller particles, the threads 166 of the auger 38 move the waste material 16 towards the suction inlet 32. Through this configuration, the suction inlet 32 is able to receive smaller processed particles of the waste material 94 that are better able to be received and moved through the suction inlet 32, as well as the vacuum system 30 of the vehicle 12. Additionally, operation of the auger 38 within the collection area 66 is able to be performed through a single motor 104 positioned at the drive end 162 of the auger 38.

According to various aspects of the device, the suction inlet 32 is disposed to one side, such as a first side 190 of the collector frame 40 and proximate to one of the first operable arm 22 and the second operable arm 24. It is typical that the suction inlet 32 can be positioned adjacent to or at the intersection between a rear wall 194 of the collector frame 40 and one of the first angled member 42 or the second angled member 44. Accordingly, the suction inlet 32 can be positioned at a corner 196 of the collector frame 40 so that waste material 16 can be manipulated towards an off-center apex 198 of the collector frame 40. The auger 38 or other agitating mechanism 10 is typically positioned to be parallel with the rear wall 194 of the collector frame 40. In particular, the auger 38 can be positioned adjacent to the rear wall 194 of the collector frame 40 and typically in alignment with the opening 200 for the suction inlet 32.

During operation of the vehicle 12 and the waste collection assembly 160, the first and second operable arms 22, 24 and the first angled member 42 and second angled member 44 direct the waste material 16 towards the rear wall 194 of the collector frame 40. The auger 38 rotates such that the threads 166 of the auger 38 can process the waste material 16 and also move the processed waste 94 towards the off-center apex 198 of the collector frame 40. Use of the auger 38 adjacent to the rear wall 194 of the collector frame 40 provides for a processing space that is approximately as wide as the collection area 66 within the collector frame 40. In this expansive area, waste material 16 can be processed for manipulation and movement toward the suction inlet 32.

Depending upon the amount of waste material 16 to be processed, the speed of the motor 104 operating the auger 38 can be increased or decreased to provide different levels of processing functionality or to move the waste material 16 at a faster or slower rate of speed toward the suction inlet 32. The motor 104 and the drive end 162 of the auger 38 are attached to the collector frame 40 proximate to one of the first operable arm 22 and the second operable arm 24. Accordingly, the motor 104 is positioned in an opposing arrangement with respect to the suction inlet 32. Stated another way, the suction inlet 32 is positioned to a first side 190 of the collector frame 40, and the motor 104 and motor housing 180 are positioned to the opposing second side 192 of the collector frame 40. In certain aspects of the device, it is contemplated that the motor 104 can be attached proximate the collector frame 40 and enclosed within the motor housing 180, wherein the motor housing 180 also surrounds a portion of the suction inlet 32.

According to various aspects of the device, as exemplified in FIGS. 9-14, the collector frame 40 can include an attachment interface 210 that is used to couple the collector frame 40 to the vehicle frame 20. In this manner, the agricultural vehicle 12 can be used for a number of different functions where different attachments can be attached to the agricultural vehicle 12. The attachment interface 210 can also be used to attach and detach the collector frame 40 from the vehicle 12 for maintenance, repair, or replacement of one or more components of the waste collection assembly 160.

According to the various aspects of the device, the waste collection assembly 160 can include the flexible member 130 that extends downward from the collector frame 40, the first operable arm 22, and the second operable arm 24 to further define the collection area 66. It is contemplated that the flexible member 130 can be a substantially continuous member that extends from an outward portion 220 of the first operable arm 22, through the length of the first operable arm 22, along the collector frame 40, and through the extent of the second operable arm 24 to an outward portion 220 of the second operable arm 24. In this manner, the flexible member 130 defines, at least partially, the collection area 66 within which the auger 38 can be used to process the waste material 16 for movement towards the suction inlet 32. To limit interaction between the waste material 16 and certain components of the waste collection assembly 160, it is contemplated the motor 104, the motor housing 180, the inlet housing 182 and certain portions of the suction inlet 32 are positioned above an upper region 230 of the flexible member 130. This configuration provides for convenient access to components of the waste collection assembly 160 for maintenance and cleaning of the flexible member 130 and the components of the waste collection assembly 160. Additionally, the auger 38 can be attached to the collector frame 40 above the flexible member 130. In this aspect of the device, the one or more threads 166 of the auger 38 extend from the central shaft 240 of the auger 38 or other agitating mechanism 10 and into a lower area 242 of the collection area 66 adjacent to the flexible member 130 and the floor 132 where the waste material 16 is located.

In certain aspects of the device, the thread 166 or plurality of threads 166 for the auger 38 can extend downward to the lower area 242 of the collection area 66 proximate the floor 132 on which the agricultural vehicle 12 operates. It is also contemplated that the one or more threads 166 of the auger 38 can extend only partially downward toward the floor 132. In such an aspect of the device, the flexible member 130 can be utilized for building up certain amounts of waste material 16 within the collection area 66. As this waste material 16 builds up, in a generally upward direction, the threads 166 of the auger 38 are able to engage and process the waste material 16 for movement toward the suction inlet 32. Through this configuration, the engagement between the flexible member 130 and the floor 132 serves to at least partially process the waste material 16 to break up clumps 80 of waste material 16. The auger 38 and the flexible member 130 can cooperate to process the waste material 16 for disintegration and movement toward the suction inlet 32.

Referring again to FIGS. 9-14, the agricultural vehicle 12 can include the collector frame 40 which is attached to a vehicle frame 20 for the agricultural vehicle 12. Opposing arms 250 are operably attached to the collector frame 40 to define the gathering region 28. The suction inlet 32 is attached to the collector frame 40 and is positioned proximate to the first operable arm 22 of the opposing arms 250. The vacuum system 30 is configured to draw the waste material 16 away from the collection area 66 via the suction inlet 32. The auger 38 includes a drive end 162 and an exit end 164. The drive end 162 is attached to the collector frame 40 and is positioned proximate to the second operable arm 24 of the opposing arms 250, and opposite to the suction inlet 32. The exit end 164 of the auger 38 is positioned proximate to the suction inlet 32. The auger 38 rotates within the collection area 66 and is configured to direct the waste material 16 toward the suction inlet 32.

According to various aspects of the device, the auger 38, as well as the other agitating mechanisms 10 described herein, rotate about a rotational axis 260. This rotational axis 260 is typically perpendicular to a central axis 262 of the collector frame 40. As described herein, the exit end 164 of the auger 38 is rotationally attached to the inlet housing 182 that at least partially surrounds the suction inlet 32. A bearing 110 can be attached between the inlet housing 182 and the exit end 164 to provide for idling and free rotation of the exit end 164 of the auger 38 when being driven by the motor 104. As further described herein, the drive end 162 of the auger 38 is attached to the motor 104 that is positioned within the motor housing 180 that surrounds and protects the motor 104 and its related components. The motor housing 180 can also include certain bearings 110 to support the position of the auger 38 and to allow for substantially free rotation of the auger 38 with respect to the motor housing 180.

Referring again to FIGS. 9-14, the waste collection assembly 160 for the vehicle 12 includes the collector frame 40 having the attachment interface 210 for attaching to a vehicle frame 20. The collector frame 40 includes the first side 190 and the second side 192 that are divided by the axis of symmetry 100. Operable opposing arms 250 are attached to the collector frame 40, with the operable opposing arms 250 and the collector frame 40 defining the gathering region 28. The suction inlet 32 is attached to the collector frame 40 within one of the first side 190 and the second side 192 of the collector frame 40. The suction inlet 32 is configured to draw the waste material 16 away from the collection area 66. As described herein, the suction inlet 32 works in conjunction with the vacuum system 30 of the vehicle 12 to generate a low-pressure suction within the collection area 66 that draws processed waste material 16, as well as certain unprocessed waste material 16, into a storage tank 18 disposed on the vehicle 12. The auger 38 includes the drive end 162 that is attached to the other of the first side 190 and the second side 192 of the collector frame 40. In this manner, the drive end 162 and the motor 104 of the auger 38 are positioned in an opposing configuration relative to the suction inlet 32. The auger 38 also includes the exit end 164 that is attached to the suction inlet 32. As the auger 38 rotates within the collection area 66, the auger 38 is configured to direct the waste material 16 toward the suction inlet 32.

As described herein, the waste collection assembly 160 is utilized for collecting and processing waste material 16 for accumulation and disposal to the suction inlet 32. Use of the single motor 104 with the auger 38 or other agitating mechanism 10 provides for a convenient waste collection assembly 160 that includes minimal parts to maintain as well as an efficient system for receiving, collecting, processing, moving, and disposing of the waste material 16. The positioning of the suction inlet 32 at the apex 46 or the off-center apex 198 provides for a convenient collection point within which the suction inlet 32 can manipulate and dispose of the waste material 16 from the collection area 66. Additionally, the positioning of the agitating mechanism 10, such as the auger 38, to be perpendicular to the central axis 262 or axis of symmetry 100 of the collector frame 40 provides for a robust area within which the waste material 16 can be processed and moved toward the suction inlet 32.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A vehicle for a livestock facility, the vehicle comprising:
a storage tank positioned on a vehicle frame;
a collector frame attached to the vehicle frame;
first and second operable arms that are attached to the collector frame and positioned proximate a front of the collector frame, the first and second operable arms at least partially defining a collection area;
a vacuum system having a suction inlet that extends from proximate the collection area to the storage tank; and
an agitating mechanism that is positioned within the collection area, the agitating mechanism operating within the collection area to process waste material and direct waste material toward the suction inlet.

2. The vehicle of claim 1, wherein the agitating mechanism is an auger that operates to direct waste material toward the suction inlet.

3. The vehicle of claim 2, wherein the suction inlet is disposed proximate an exit end of the auger.

4. The vehicle of claim 2, wherein the suction inlet is positioned to one side of the collection area.

5. The vehicle of claim 2, wherein the agitating mechanism is operated by a dedicated motor that is attached to the collector frame.

6. The vehicle of claim 5, wherein the dedicated motor is disposed within a motor housing that is attached to the collector frame.

7. The vehicle of claim 2, wherein the suction inlet is disposed to one side of the collector frame proximate one of the first operable arm and the second operable arm.

8. The vehicle of claim 5, wherein the dedicated motor is attached to the collector frame proximate to the other of the first operable arm and the second operable arm.

9. The vehicle of claim 3, wherein the exit end of the auger is attached to an inlet housing that partially surrounds the suction inlet.

10. The vehicle of claim 2, wherein a flexible member extends downward from the collector frame, the first operable arm, and the second operable arm to further define the collection area.

11. The vehicle of claim 10, wherein the auger is attached to the collector frame above the flexible member, wherein a thread of the auger extends downward and into the collection area adjacent to the flexible member.

12. A vehicle for a livestock facility, the vehicle comprising:
a collector frame configured to attach to a vehicle frame;
opposing arms that are operably attached to the collector frame, the opposing arms defining a collection region;
a suction inlet attached to the collector frame and positioned proximate to a first operable arm of the opposing arms, the suction inlet configured to draw a waste material away from the collection region; and
an auger having a drive end and an exit end, wherein the drive end is attached to the collector frame and positioned proximate to a second operable arm of the opposing arms, and wherein the exit end is positioned proximate the suction inlet, wherein the auger rotates within a collection area and is configured to direct the waste material toward the suction inlet.

13. The vehicle of claim 12, wherein the auger rotates about a rotational axis that is perpendicular to a central axis of the collector frame.

14. The vehicle of claim 12, wherein the exit end of the auger is rotationally attached to the suction inlet.

15. The vehicle of claim 12, wherein the suction inlet is positioned to one side of the collection area and a motor that drives the auger is positioned to an opposing side of the collection area.

16. The vehicle of claim 12, wherein a flexible member extends downward from the collector frame, the first operable arm, and the second operable arm to further define the collection area.

17. The vehicle of claim 16, wherein the auger is attached to the collector frame above the flexible member, wherein a thread of the auger extends downward and into the collection area adjacent to the flexible member.

18. A waste collection assembly for a vehicle, the waste collection assembly comprising:
a collector frame having an attachment interface for attaching to a vehicle frame, the collector frame having a first side and a second side that are divided by an axis of symmetry;
opposing operable arms that are attached to the collector frame, the opposing arms defining a collection region;
a suction inlet attached to the first side of the collector frame, the suction inlet configured to draw a waste material away from the collection region; and
an auger having a drive end that is attached to the second side of the collector frame and an exit end that is attached to the suction inlet, wherein the auger rotates within a collection area and is configured to direct the waste material toward the suction inlet.

19. The vehicle of claim 18, wherein the exit end of the auger is attached to an inlet housing that partially surrounds the suction inlet.

20. The vehicle of claim 18, wherein a flexible member extends downward from the collector frame, the first operable arm, and the second operable arm to further define the collection area, and wherein the auger is attached to the collector frame above the flexible member, wherein a thread of the auger extends downward and into the collection area adjacent to the flexible member.
